(19) United States
(12) Patent Application Publication
(10) Pub. No.: US 2026/0292043 A1
(43) Pub. Date: Sep. 24, 2026

(54) COMMUNICATION SYSTEM, TRANSMITTING DEVICE, AND RECEIVING DEVICE

(71) Applicant: RENESAS ELECTRONICS CORPORATION, Tokyo (JP)

(72) Inventor: Toshinori TAMASHIRO, Tokyo (JP)

(21) Appl. No.: 19/463,217

(22) Filed: Jan. 29, 2026

(30) Foreign Application Priority Data
Mar. 24, 2025 (JP) 2025-048356

(51) Int. Cl. H04L 67/568; H04L 67/563

(52) U.S. Cl. CPC H04L 67/568; H04L 67/563

(57) ABSTRACT

The communication load of log data between the transmission device and the receiving device is suppressed. The transmission device 10, based on the first data set 40a containing communicated log data 41_n−1 that completely matches the log data 30 generated by the application 16 being stored in the cache 12, transmits the identifier 42_n−1 included in the first data set 40a instead of the log data 30. Receiving device 20 reads the log data 41_n−1 corresponding to the identifier 42_n−1 received from the transmission device 10 from the cache 22 and manages the read log data 41_n−1 as the log data 30.

### CROSS-REFERENCE TO RELATED APPLICATIONS

The disclosure of Japanese Patent Application No. 2025-048356 filed on Mar. 24, 2025, including the specification, drawings and abstract is incorporated herein by reference in its entirety.

### BACKGROUND

The present disclosure relates to a communication system, a transmitting device, a receiving device, a transmitting method, a receiving method, and a program, and can be suitably used for a communication system that communicates log data and the transmitting and receiving devices included in the communication system.

Recently, technology for managing log data generated by the execution of various applications has been developed. Log data can be utilized for various purposes.

The conventional technology related to the present disclosure has been described based on general technical information known to the applicant, but within the scope of the applicant's knowledge, the applicant does not have information that should be disclosed as prior art document information before the application

### SUMMARY

Log data is communicated from the transmitting device that generates the log data to the receiving device that manages the log data. When a large amount of log data is communicated, the communication bandwidth between the transmitting device and the receiving device is strained. When the communication bandwidth is strained, it causes problems in the operation of applications or the operating system (OS). Therefore, it is desirable to suppress the communication load of log data between the transmitting device and the receiving device.

Other objects and novel features will become apparent from the description of this specification and the accompanying drawings.

According to one embodiment, a communication system for communicating log data comprises a transmission device and a receiving device. The transmission device includes a first cache and an application that generates log data. The receiving device includes a second cache. The first cache and the second cache store one or more datasets including communicated log data and an identifier assigned to the communicated log data. The transmission device sends the identifier included in the first dataset instead of the first log data, in response to that the first dataset containing the communicated log data that completely matches the first log data generated by the application is stored in the first cache. The receiving device reads the communicated log data corresponding to the identifier received from the transmission device from the second cache and manages the read communicated log data as the first log data. According to one embodiment, a transmission device for transmitting log data to a receiving device comprises a first cache, an application that generates the log data, and a processor. The first cache stores the same one or more data sets as the second cache included in the receiving device, each of the one or more data sets including communicated log data and a uniquely assigned identifier to the communicated log data. The processor controls the transmission device to send the identifier included in the first data set to the receiving device instead of the first log data, based on the first data set containing communicated log data that completely matches the first log data generated by the application being stored in the first cache.

According to one embodiment, a receiving device for receiving log data from a transmission device that generates the log data comprises a second cache configured to store the same data as the first cache provided by the transmission device, an application that manages the log data, and a processor. The second cache stores one or more data sets including communicated log data and an identifier assigned to the communicated log data. The processor reads the communicated log data corresponding to the identifier from the second cache based on receiving the identifier from the transmission device instead of the first log data generated by the transmission device. The application manages the communicated log data read from the second cache as the first log data.

According to the aforementioned embodiment, the communication load of log data between the transmitting device and the receiving device is suppressed.

### BRIEF DESCRIPTION OF THE DRAWINGS

FIG. 1 is a diagram illustrating an example of the configuration of a communication system according to the embodiment.

FIG. 2 is a diagram illustrating an example of processing in a communication system according to a reference form.

FIG. 3 is a diagram illustrating the data stored in the cache shown in FIG. 1.

FIG. 4 is a flowchart showing the processing flow of the transmitting device according to the first embodiment.

FIG. 5 is a flowchart showing the processing flow of the receiving device according to the first embodiment.

FIG. 6 is a diagram illustrating the data flow in the communication system when NO is determined in step S1 shown in FIG. 4 and YES is determined in step S41 shown in FIG. 5.

FIG. 7 is a diagram illustrating the data flow in the communication system when YES is determined in step S1 shown in FIG. 4 and NO is determined in step S41 shown in FIG. 5.

FIG. 8 is a diagram illustrating the verification results of the communication volume suppression effect by the communication system according to the first embodiment.

FIG. 9 is a diagram illustrating the processing of the transmitting device according to the second embodiment.

FIG. 10 is a diagram illustrating the processing of the receiving device according to the second embodiment.

FIG. 11 is a flowchart showing the processing flow of the transmitting device according to the second embodiment.

FIG. 12 is a flowchart showing the processing flow of the receiving device according to the second embodiment.

FIG. 13 is a diagram illustrating the data flow in the communication system when YES is determined in step S11 shown in FIG. 11 and YES is determined in step S51 shown in FIG. 12.

FIG. 14 is a diagram illustrating an example of processing in the communication system according to the second embodiment.

FIG. 15 is a diagram illustrating the configuration of the cache provided in the transmitting device according to the third embodiment.

FIG. 16 is a flowchart showing the processing flow of the transmitting device according to the third embodiment.

FIG. 17 is a diagram illustrating the data flow in the transmitting device when YES is determined in step S11 shown in FIG. 16.

FIG. 18 is a diagram illustrating the data flow in the transmitting device when YES is determined in step S22 shown in FIG. 16.

### DETAILED DESCRIPTION

The embodiments of the present disclosure will be described in detail below with reference to the drawings. Note that the same reference numerals are assigned to the same or corresponding parts, and their descriptions are not repeated.

### First Embodiment

### <Overall Configuration of the Communication System>

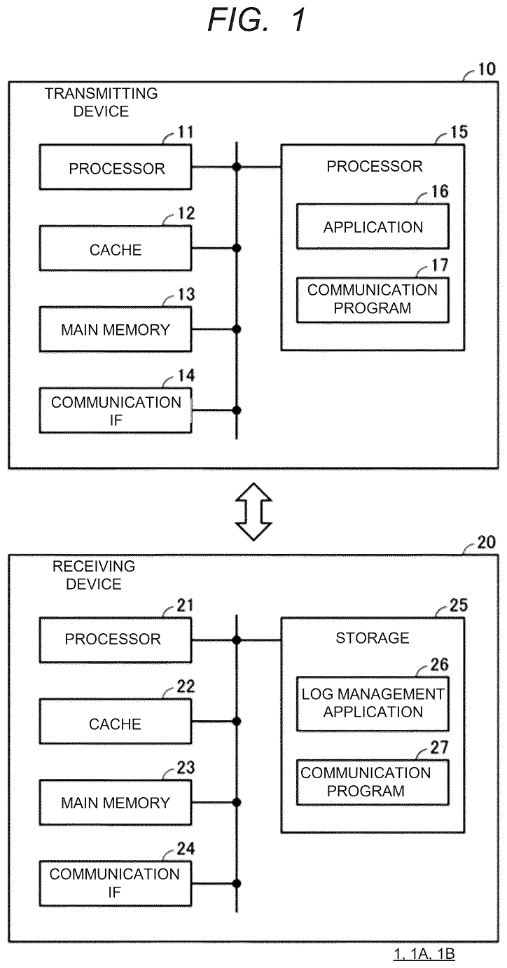

FIG. 1 is a diagram illustrating an example of the configuration of a communication system according to the embodiment. As shown in FIG. 1, communication system 1 according to the first embodiment includes a transmitting device 10 and a receiving device 20.

The transmitting device 10 is configured by, for example, an integrated circuit, SoC (System on Chip), or a computer. The receiving device 20 is configured by, for example, an integrated circuit, SoC, computer, server, or a virtual machine built on a cloud environment.

The transmitting device 10 and the receiving device 20 communicate with each other. The communication method may include, for example, Ethernet (registered trademark) and bus. For example, when the transmitting device 10 is an SoC mounted on a vehicle and the receiving device 20 is a cloud server, Ethernet is used as the communication method between the transmitting device 10 and the receiving device 20. When the transmitting device 10 and the receiving device 20 are mounted on the same board, a bus is used as the communication method between the transmitting device 10 and the receiving device 20.

The transmitting device 10 includes a processor 11, a cache 12, a main memory 13, a communication interface (IF) 14, and a storage 15. The cache 12 is an example of the “first cache” in the present disclosure.

Receiving device 20 includes a processor 21, a cache 22, a main memory 23, a communication interface 24, and a storage 25. The cache 22 is an example of the “second cache” in the present disclosure.

Processors 11, 21 include, for example, a CPU (Central Processing Unit) or DSP (Digital Signal Processor). Processors 11, 21 each read the programs stored in storages 15, 25 and deploy them in the main memories 13, 23. The processors 11, 21 execute the deployed programs.

The caches 12, 22 are configured by, for example, SRAM (Static Random Access Memory) that allows high-speed data reading and writing. The caches 12, 22 are each accessed by processors 11, 21. Note that the caches 12, 22 may be built into processors 11, 21.

The main memories 13, 23 include, for example, volatile storage devices such as DRAM (Dynamic Random Access Memory) or SRAM.

The communication interfaces 14, 24 communicate with each other using communication methods such as Ethernet and bus. The communication interfaces 14, 24 communicate the log data described later.

The storages 15, 25 include, for example, non-volatile storage devices such as HDD (Hard Disc Drive), SSD (Solid State Drive), or flash memory. The storages 15, 25 store the programs executed by the processors 11, 21, respectively.

Specifically, the storage 15 stores, an application 16 and a communication program 17. The storage 2 stores a log management application 26 and a communication program 27. Furthermore, the storages 15, 25 store an OS not shown.

Application 16 includes a set of instructions for controlling a control target or a set of instructions for monitoring a monitoring target. For example, when the transmitting device 10 is an SoC mounted on a vehicle, application 16 includes a set of instructions for controlling the acceleration of the vehicle according to the operation amount of the accelerator pedal. Alternatively, application 16 includes a set of instructions for switching the on/off of LEDs included in the headlights according to the surrounding environment of the vehicle. Alternatively, application 16 includes a set of instructions for monitoring the state of components mounted on the vehicle.

Application 16 generates various log data. Log data typically indicates the state of the control target or monitoring target. For example, if the transmission device 10 is an SoC mounted on a vehicle, the log data indicates the vehicle's acceleration. Alternatively, the log data indicates the state of the LED (on or off). Application 16 can periodically generate log data.

Communication program 17 includes a set of instructions to control the transmission of log data to suppress the communication volume of log data.

Log management application 26 includes a set of instructions to manage the log data generated by application 16. Log data managed by log management application 26 can be used for various purposes such as statistics, evaluation, detection of specific timings, and updating control algorithms. For example, if the transmission device 10 is a SoC mounted on a vehicle and the log data indicates acceleration, the log data is used for evaluating driving skills or updating the set of instructions to control acceleration. Alternatively, if the log data indicates the state of the LED, the log data can be used to detect the timing when the LED switches from on to off.

Communication program 27 includes a set of instructions to control the reception of log data to suppress the communication volume of log data.

### <Problems of the Reference Form>

Before explaining the details of communication system 1 according to the first embodiment, the problems of the communication system according to the reference form are explained.

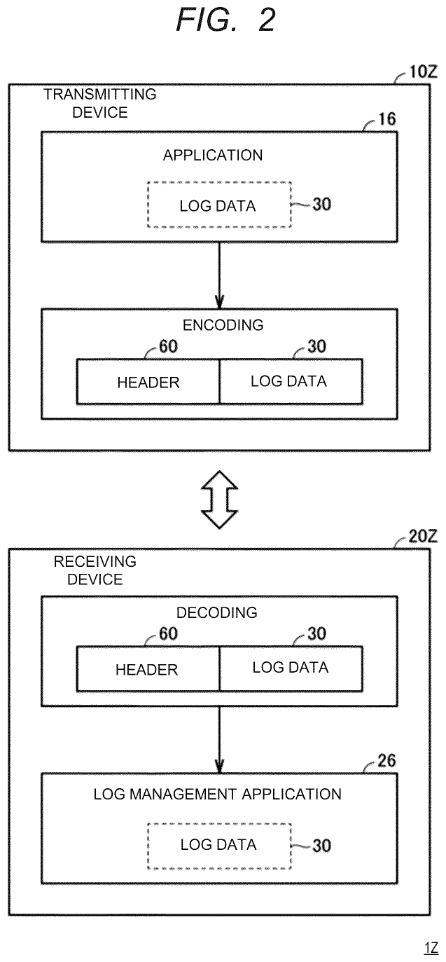

FIG. 2 is a diagram showing a processing example of the communication system according to the reference form. As shown in FIG. 2, the communication system 1Z according to the reference form includes a transmission device 10Z and a reception device 20Z.

Transmission device 10Z includes processor 11 and application 16 as shown in FIG. 1. Processor 11 of transmission device 10Z adds header 60 to log data 30 each time application 16 newly generates log data 30. Header 60 has a format specified by the communication protocol. Processor 11 encodes header 60 and log data 30. Encoded header 60 and log data 30 are transmitted to reception device 20Z.

Reception device 20Z includes processor 21 and log management application 26 as shown in FIG. 1. Reception device 20Z receives encoded header 60 and log data 30 from transmission device 10. Processor 21 of reception device 20Z decodes header 60 and log data 30. Log management application 26 manages the decoded log data 30.

According to communication system 1Z of the reference form, log data 30 is communicated after being encoded. Therefore, a certain degree of reduction in the communication volume of log data 30 is expected. However, application 16 can generate log data for each of multiple control targets and multiple monitoring targets. For example, f transmission device 10Z is an SoC mounted on a vehicle, application 16 can generate log data 30 representing the state for each of the multiple components included in the vehicle. Additionally, the transmission cycle of log data can be set short. Due to these factors, a large amount of log data 30 can be communicated from transmission device 10Z to reception device 20Z. As a result, the communication bandwidth between transmission device 10Z and reception device 20Z is strained, causing operational issues for application 16 or an unillustrated OS.

### <Cache>

Communication system 1 according to the first embodiment, uses caches 12, 22 to communicate log data 30 to solve the above problems.

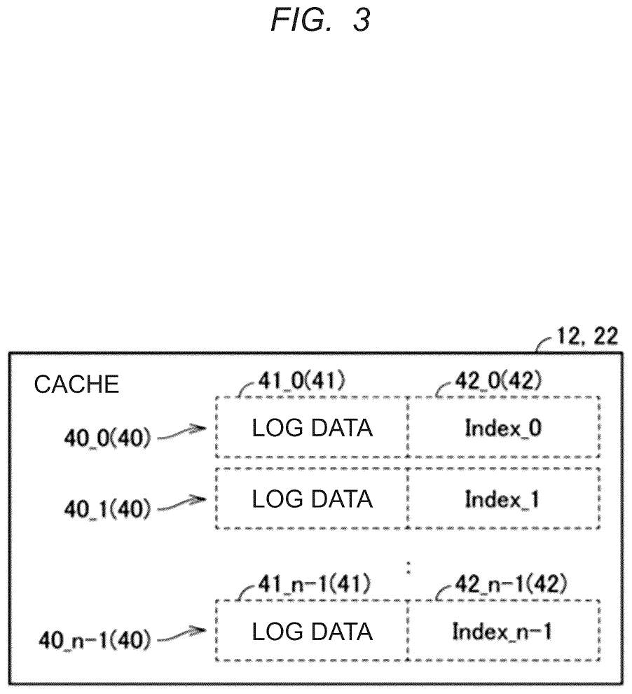

FIG. 3 is a diagram showing data stored in the cache shown in FIG. 1. Caches 12, 22 are configured to hold the same data. Therefore, caches 12, 22 are also referred to as Dual Synchronized Cache.

As shown in FIG. 3, each of caches 12, 22 stores one or more data sets 40. In the example shown in FIG. 3, each of caches 12, 22 stores n data sets 40 (from data set 40_0 to data set 40_n−1). Each data set 40 includes log data 41 communicated from transmission device 10 to reception device 20 in the past and a uniquely assigned identifier 42 for log data 41. Specifically, the k-th data set 40_k (where k is an integer from 0 to n−1) includes log data 41_k and identifier 42_k. Log data 41 is an example of the “communicated log data” disclosed herein. Identifier 42_k represents the index number “index k”.

### <Processing Flow>

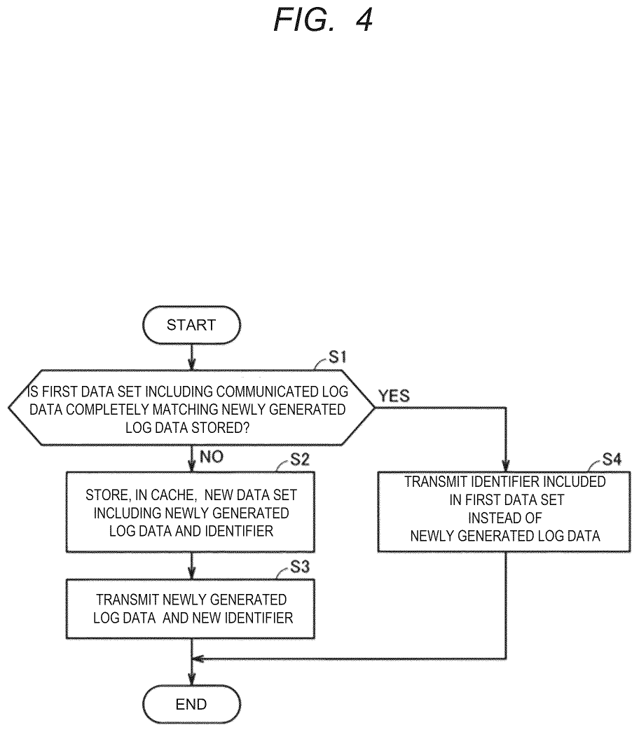

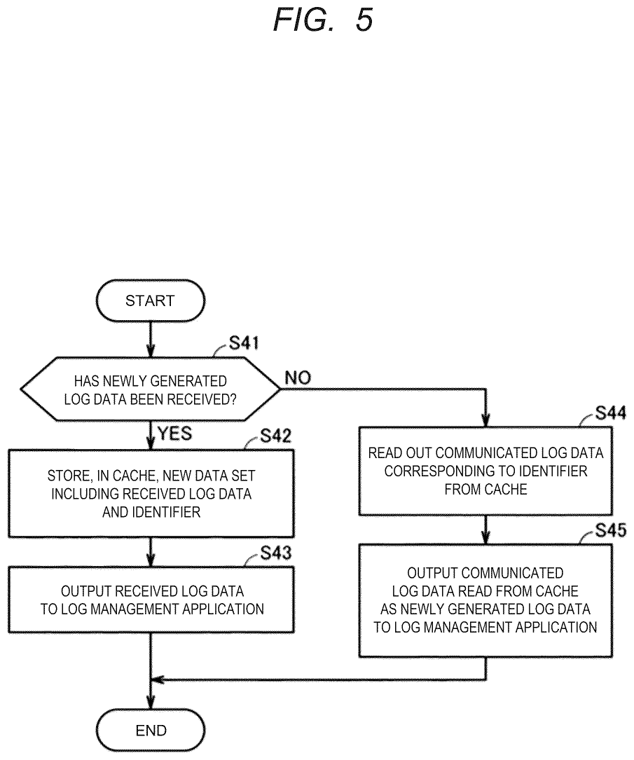

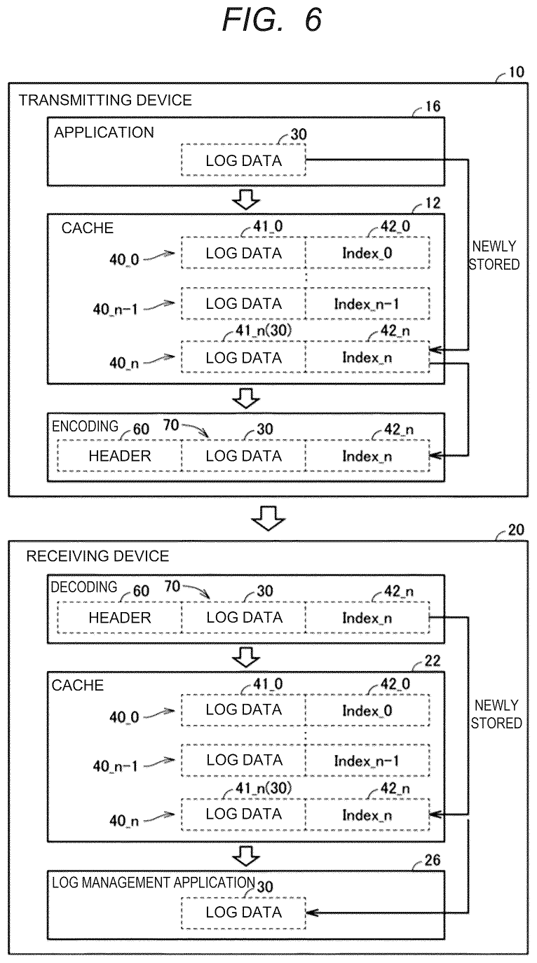

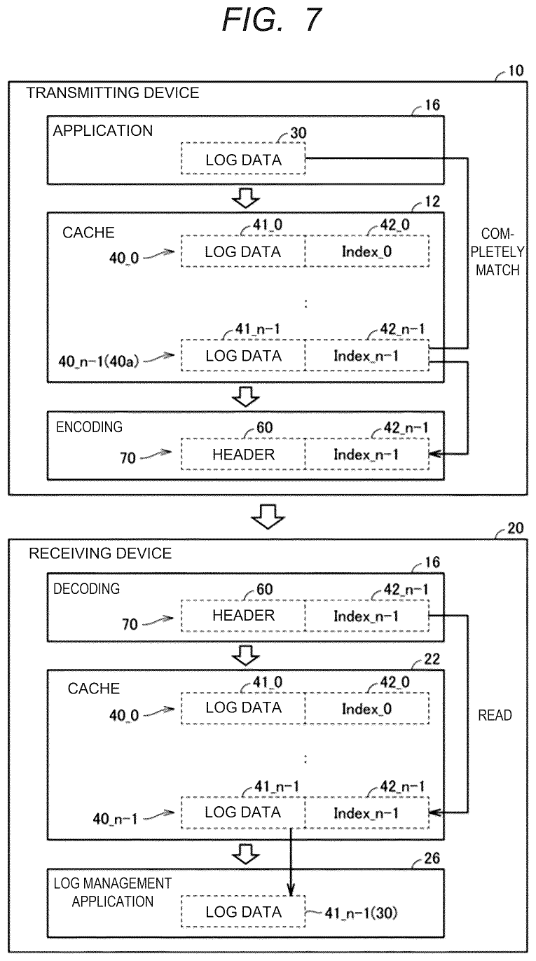

Referring to FIGS. 4 to 7, the processing flow of communication system 1 according to the first embodiment is explained. FIG. 4 is a flowchart showing the processing flow of the transmission device according to the first embodiment. FIG. 5 is a flowchart showing the processing flow of the reception device according to the first embodiment. FIG. 6 is a diagram showing the data flow in the communication system when NO is determined in step S1 shown in FIG. 4 and YES is determined in step S41 shown in FIG. 5. FIG. 7 is a diagram showing the data flow in the communication system when YES is determined in step S1 shown in FIG. 4 and NO is determined in step S41 shown in FIG. 5. Note that FIGS. 6 and 7 show examples when caches 12, 22 store n data sets 40 (from data set 40_0 to data set 40_n−1) at the start of steps S1 and S41.

The flow shown in FIG. 4 is executed each time application 16 newly generates log data 30. Log data 30 newly generated by application 16 is an example of the “first log data” disclosed herein. The set of instructions executed from step S1 to step S4 by processor 11 is included in communication program 17.

As shown in FIG. 4, in step S1, processor 11 of transmission device 10 determines whether the first data set 40a is stored in cache 12. The first data set 40a is a data set that includes log data 41 that completely matches the newly generated log data 30.

If the first data set 40a is not stored in cache 12 (NO in step S1), the process moves to step S2. In step S2, processor 11 stores a new data set 40 in cache 12, which includes the newly generated log data 30 as communicated log data 41 and a new identifier 42. In the example shown in FIG. 6, processor 11 stores a new data set 40_n in cache 12, which includes the newly generated log data 30 as communicated log data 41_n and a new identifier 42_n.

In the next step S3, processor 11 controls transmission device 10 to transmit the newly generated log data 30 and the new identifier 42_n. Specifically, as shown in FIG. 6, processor 11 adds header 60 to log data 30 and new identifier 42_n, and encodes header 60, log data 30, and identifier 42_n. Subsequently, processor 11 controls communication interface 14 to transmit packet 70, which includes encoded header 60, log data 30, and identifier 42_n, to reception device 20.

If the first data set 40a is stored in cache 12 (YES in step S1), the process moves to step S4. In the example shown in FIG. 7, log data 30 completely matches log data 41_n−1. Therefore, processor 11 identifies data set 40_n−1, which includes log data 41_n−1, as the first data set 40a and then executes step S4.

In step S4, processor 11 controls transmission device 10 to transmit the identifier 42 included in the first data set 40a instead of the newly generated log data 30. In the example shown in FIG. 7, processor 11 controls transmission device 10 to transmit identifier 42_n−1 included in the data set 40_n−1 identified as the first data set 40a. Specifically, processor 11 adds header 60 to identifier 42_n−1 and encodes header 60 and identifier 42_n−1. Subsequently, processor 11 controls communication interface 14 to transmit packet 70, which includes encoded header 60 and identifier 42_n−1, to reception device 20.

The flow shown in FIG. 5 is executed each time reception device 20 receives packet 70. The set of instructions executed from step S41 to step S45 by processor 21 is included in communication program 27.

As shown in FIG. 5, first in step S41, processor 21 of reception device 20 determines whether the newly generated log data 30 has been received. Specifically, as shown in FIGS. 6 and 7, processor 21 decodes the received packet 70. Processor 21 determines, for example, based on the decoded header 60, whether the decoded packet 70 includes log data 30. If packet 70 includes log data 30, processor 21 determines that the newly generated log data 30 has been received.

If log data 30 is received (YES in step S41), the process moves to step S42. In step S42, processor 21 stores a new data set 40, which includes the received log data 30 as communicated log data 41 and the received identifier 42, in the cache 22. In the example shown in FIG. 6, processor 21 stores a new data set 40_n, which includes the received log data 30 as communicated log data 41_n and the received identifier 42_n, in the cache 22. As a result, the data stored in cache 22 matches the data stored in cache 12.

In the next step S43, processor 21 outputs the received log data 30 to the log management application 26. As a result, as shown in FIG. 6, the log management application 26 can manage the newly generated log data 30 by application 16.

If the log data 30 is not received (NO in step S41), the process moves to step S44. In the example shown in FIG. 7, the decoded packet 70 includes a header 60 and identifier 42_n−1, but does not include log data 30. Therefore, processor 11, after determining that log data 30 has not been received, proceeds to implement step S44.

In step S44, processor 21 reads out log data 41 corresponding to the received identifier 42 from cache 22. In the example shown in FIG. 7, processor 11 reads out log data 41_n−1 corresponding to identifier 42_n−1 from cache 22.

In the next step S45, processor 21 outputs the log data 41 read from cache 22 as newly generated log data 30 to the log management application 26. As a result, the log management application 26 accepts the log data 41 read from cache 22 as newly generated log data 30.

In the example shown in FIG. 7, processor 21 outputs log data 41_n−1 as newly generated log data 30 to the log management application 26. As mentioned above, log data 41_n−1 completely matches log data 30. Therefore, log management application 26 can manage log data 41_n−1 as newly generated log data 30.

It should be noted that cache 12 has a finite capacity. Therefore, in step S2, if the size of the new data set 40_n is smaller than the available capacity of cache 12, processor 11 omits step S2.

Alternatively, in step S2, if the size of the new data set 40_n is smaller than the available capacity of cache 12, processor 11 erases the data set 40 with the oldest storage date and time from cache 12. Or processor 11 erases the data set 40 with the oldest storage date and time among one or more data sets with a count below the threshold identified as the first data set 40a from cache 12. This allows processor 11 to store the new data set 40_n in cache 12.

Processor 11 outputs an erase instruction specifying the identifier 42 included in the data set 40 erased from cache 12 to the receiving device 20. Upon receiving the erase instruction, processor 21 of the receiving device 20 erases the data set 40 containing the specified identifier 42 from cache 22. As a result, the data stored in cache 22 matches the data stored in cache 12.

### Verification Results of Effects

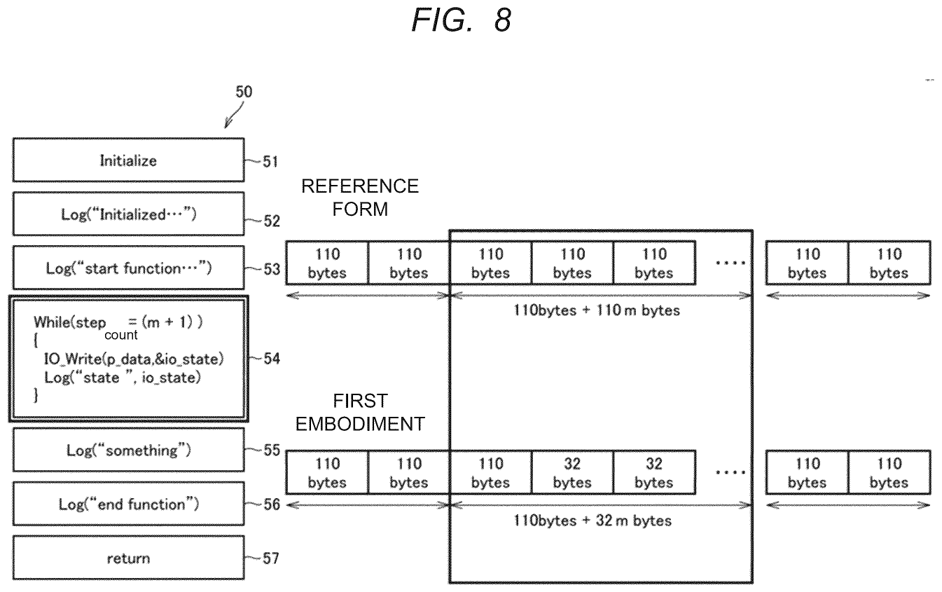

FIG. 8 is a diagram showing the verification results of the communication volume suppression effect by the communication system according to the first embodiment. FIG. 8 shows the verification results when application 16 implements process flow 50.

Process flow 50 includes initialization process 51, initialization start log generation process 52, function start log generation process 53, loop process 54, function execution result log generation process 55, function end log generation process 56, and return process 57. Loop process 54 is a process that repeats a process set including IO data writing process and state log generation process representing the state of the monitored object (m+1) times. In process flow 50, log data is generated in the generation processes 52, 53, 55, 56, and each of the (m+1) times state log generation process. That is, log data is generated (m+5) times.

In the communication system 1Z according to the reference form (see FIG. 2), the transmitting device 10Z and the receiving device 20Z do not have caches 12, 22. Therefore, each time log data is generated, packets containing the log data are communicated from the transmitting device 10Z to the receiving device 20. If the size of the log data is 80 bytes and the size of the header is 30 bytes, the packet size becomes 110 bytes. As mentioned above, in process flow 50, log data is generated (m+5) times. Therefore, the communication volume of log data in process flow 50 is 110 multiplied by (m+5) bytes.

On the other hand, in communication system 1 according to the first embodiment, if the first data set 40a is stored in cache 12, the transmitting device 10 sends the identifier 42 included in the first data set 40a instead of log data 30. If the size of identifier 42 is 2 bytes, the size of packet 70 including header 60 and identifier 42 is 32 bytes. Therefore, by sending identifier 42 instead of log data 30, the communication volume per transmission is reduced to 29% (=100 multiplied by 32/110).

If the state of the monitored object does not change during the implementation of loop process 54, the same log data 30 is always generated in the process set repeated (m+1) times. The log data 30 generated during the first implementation of the process set is sent t from the transmitting device 10 to the receiving device 20 and included as communicated log data 41 in the data set 40 newly registered in cache 12. Therefore, cache 12 stores a data set 40 that includes log data 41 completely matching log data 30 generated during the implementation of each of the remaining m process sets. As a result, when implementing the remaining m process sets, a packet 70 containing identifier 42 is sent from the transmitting device 10 to the receiving device 20 instead of log data 30. At this time, the communication volume of log data in process flow 50 is {110 multiplied by 5+32 multiplied by m} bytes.

If m is 20, the communication volume of log data in communication system 1 is reduced to 43% [=100 multiplied by {110 multiplied by 5+32 multiplied by 20}/(110 multiplied by 25)] compared to the communication volume of log data in communication system 1Z.

Thus, according to communication system 1 of the first embodiment, if the first data set 40a containing log data 41 completely matching the newly generated log data 30 is stored in cache 12, identifier 42 is communicated instead of log data 30. The data size of identifier 42 is smaller than the size of log data 30. Therefore, the communication load of log data between the transmitting device 10 and the receiving device 20 is suppressed.

### Second Embodiment

Communication system 1A according to the second embodiment has a similar configuration to the communication system 1 according to the first embodiment (see FIG. 1).

According to communication system 1 of the first embodiment, if the first data set 40a is not stored in cache 12, processor 11 controls the transmitting device 10 to send the newly generated log data 30. The log data generated by application 16, for example, indicates the state of the monitored object. If the change in state is small, log data generated at one timing may not completely match log data generated at another timing but may largely match. Therefore, communication system 1A according to the second embodiment implements a process to suppress communication volume even when log data 41 largely matching the newly generated log data 30 is stored in cache 12.

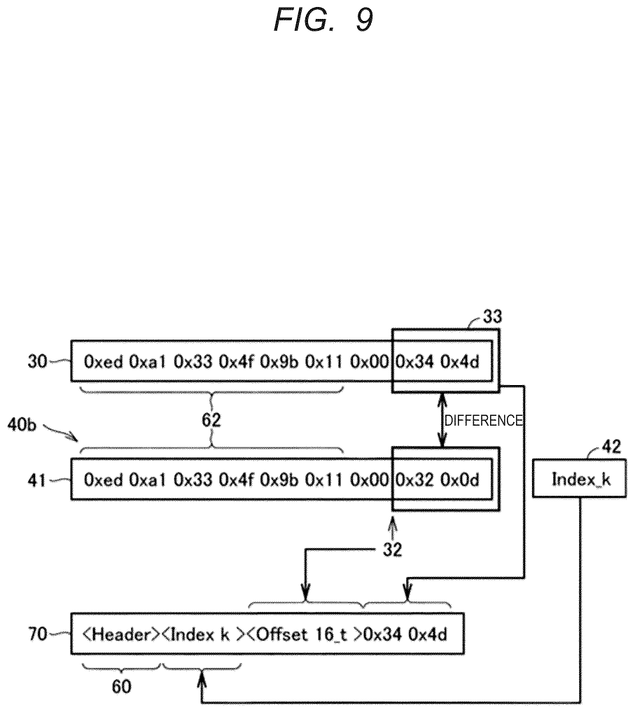

FIG. 9 is a diagram explaining the process of the transmitting device according to the second embodiment. Processor 11 of transmitting device 10 determines whether the second data set 40b is stored in cache 12 in response to that the first data set 40a is not stored in cache 12. The second data set 40b is a data set that includes communicated log data 41 with at least a specific part 62 matching the newly generated log data 30.

Processor 11 generates position information 32 and difference data 33 in response to that the second data set 40b is stored in cache 12. Position information 32 indicates the position of the part of log data 41 included in the second data set 40b that does not match log data 30. Difference data 33 is the data of the part of log data 30 that differs from log data 41 included in the second data set 40b.

In the example shown in FIG. 9, specific part 62 is a continuous part of a predetermined size from the beginning. In this case, position information 32 indicates the offset from the beginning to the start position of the part that does not match log data 30 in log data 41 included in the second data set 40b. In this case, the part of log data 41 after the offset indicated by position information 32 is the part that does not match log data 30.

It should be noted that the specific part 62 is not limited to this. For example, a specific portion 62 may be a continuous portion of a predetermined size up to the end. In this case, the location information 32 indicates the offset to the end position of the portion that does not match the log data 30 from the beginning in the log data 41 included in the second data set 40b. In this case, the portion from the beginning to the offset indicated by the location information 32 in log data 41 is the portion that does not match the log data 30.

Alternatively, the specific portion 62 may include a first portion that is continuous for a predetermined size from the beginning and a second portion that is continuous for a predetermined size up to the end. In this case, the location information 32 indicates the first offset and the second offset. The first offset is the offset to the start position of the portion that does not match the log data 30 from the beginning in the log data 41 included in the second data set 40b. The second offset is the offset to the end position of the portion that does not match the log data 30 from the beginning in the log data 41 included in the second data set 40b. In this case, the portion from the first offset to the second offset indicated by the location information 32 in log data 41 is the portion that does not match the log data 30.

Processor 11 controls the transmission device 10 to send the location information 32, the difference data 33, and the identifier 42 included in the second data set 40b instead of the newly generated log data 30, in response to that the second data set 40b is stored in the cache 12. Specifically, processor 11 generates packet 70 including the header 60, location information 32, difference data 33, and identifier 42, and controls the communication interface 14 to send the packet 70.

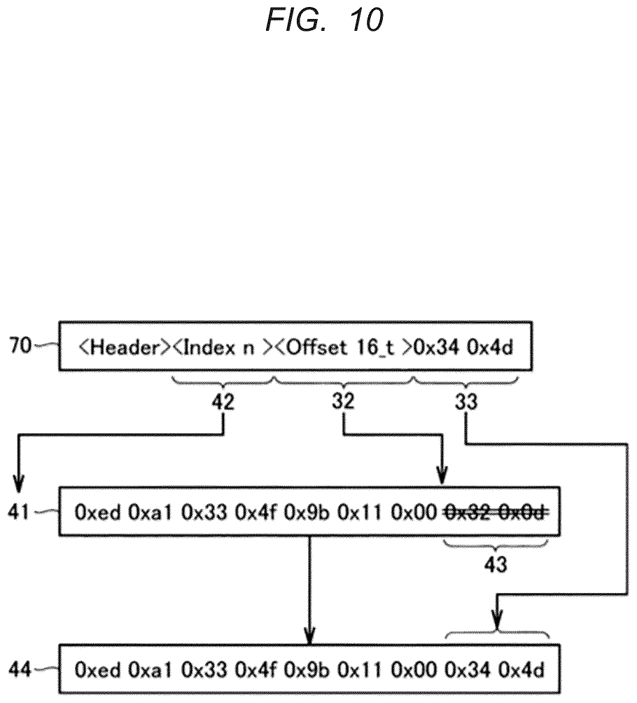

FIG. 10 is a diagram illustrating the processing of the receiving device according to the second embodiment. Processor 21 of the receiving device 20 reads the log data 41 corresponding to the identifier 42 from the cache 22 in response to receiving the packet 70 including the location information 32, difference data 33, and identifier 42. The processor 21 generates converted data 44 by replacing the portion data 43 at the position indicated by the location information 32 in the log data 41 read from the cache 22 with the difference data 33. The processor 21 outputs the converted data 44 as the newly generated log data 30 to the log management application 26.

The log data 41 included in the second data set 40b stored in the cache 12 does not match the log data 30 at the portion of the position indicated by the location information 32. The caches 12, 22 store the same data set. Therefore, the log data 41 corresponding to the identifier 42 received from the transmission device 10 and read from the cache 22 of the receiving device 20 is identical to the log data 41 included in the second data set 40b. Thus, the converted data 44 obtained by replacing the portion data 43 of the log data 41 read from the cache 22 with the difference data 33 is identical to the newly generated log data 30. As a result, the log management application 26 can accept and manage the converted data 44 as the newly generated log data 30.

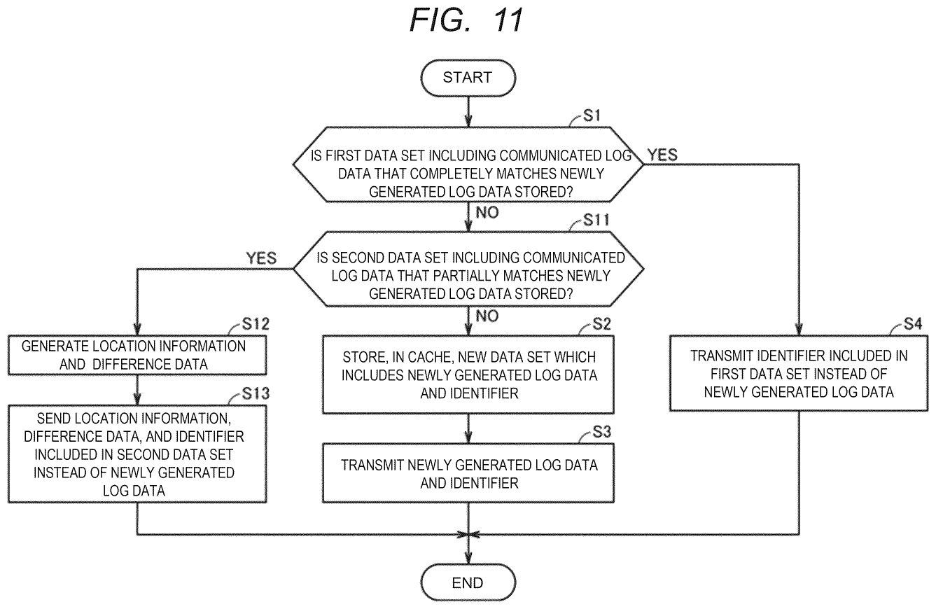

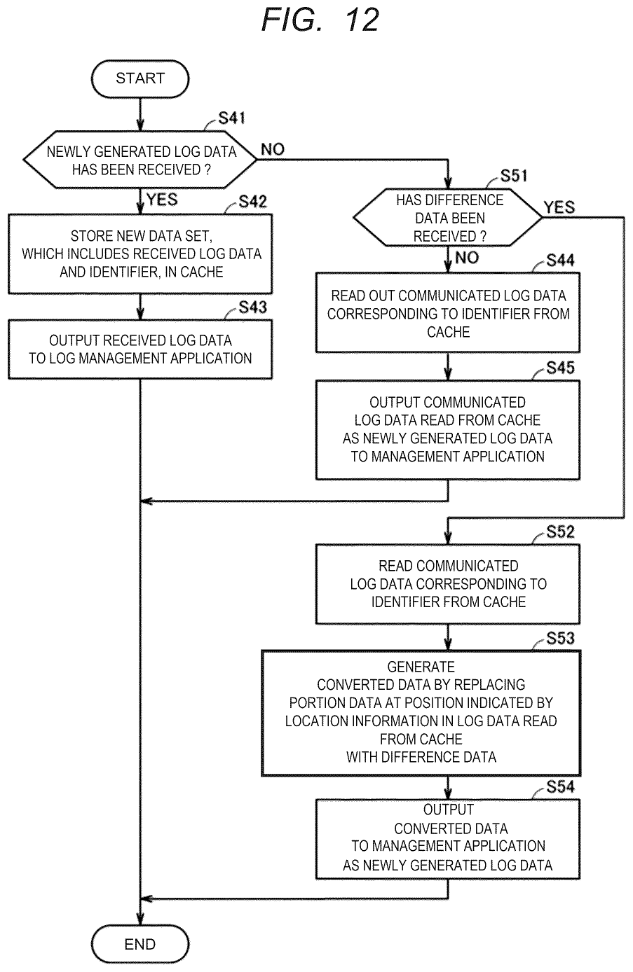

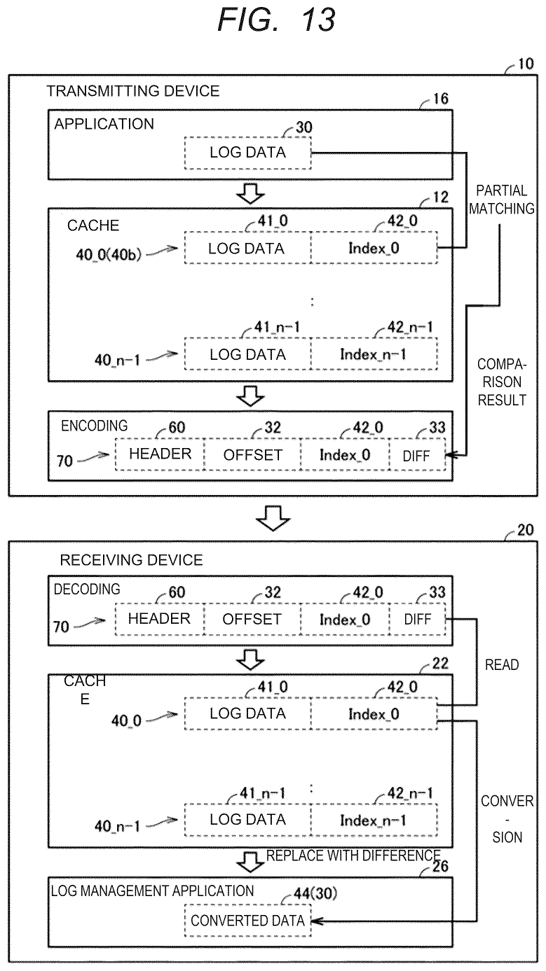

Referring to FIGS. 11 to 13, the processing flow of the communication system 1A according to the second embodiment will be described. FIG. 11 is a flowchart showing the processing flow of the transmission device according to the second embodiment. FIG. 12 is a flowchart showing the processing flow of the receiving device according to the second embodiment. FIG. 13 is a diagram showing the data flow in the communication system when it is determined as YES in step S11 shown in FIG. 11 and as YES in step S51 shown in FIG. 12. Note that FIG. 13 shows an example when the caches 12, 22 store n data sets 40 (data sets 40_0 to 40_n−1) shown in FIG. 3 at the start of steps S1, S41.

The flow shown in FIG. 11 is executed each time the application 16 newly generates log data 30. The flow shown in FIG. 11 differs from the flow shown in FIG. 4 in that it includes steps S11, S12, S13. Therefore, the differences will be explained. Note that the instruction group for executing steps S11, S12, S13 by the processor 11 is included in the communication program 17.

As shown in FIG. 11, if the first data set 40a is not stored in cache 12 (NO in step S1), the process moves to step S11. In step S11, processor 11 of the transmission device 10 determines whether the second data set 40b is stored in the cache 12. As described above, the second data set 40b is a data set that includes communicated log data 41 in which at least a specific portion 62 matches with the newly generated log data 30.

Note that the cache 12 may store two or more data sets 40 that include log data 41 in which at least a specific portion 62 matches with the log data 30. In this case, processor 11 determines one of the two or more data sets 40 as the second data set 40b. For example, the processor 11 identifies the data set that includes the log data 41 with the smallest difference from the log data 30 among the two or more data sets 40 as the second data set 40b.

If the second data set 40b is not stored in the cache 12 (NO in step S11), steps S2, S3 are executed.

If the second data set 40b is stored in the cache 12 (YES in step S11), the process moves to step S12. In the example shown in FIG. 13, the log data 41_0 matches in at least a specific portion 62 (see FIG. 9) with the log data 30. Therefore, processor 11 identifies the data set 40_0 that includes the log data 41_0 as the second data set 40b and then executes step S12.

In step S12, processor 11 generates location information 32 indicating the position of the portion that does not match the log data 30 in the log data 41 included in the second data set 40b. Furthermore, the processor 11 generates difference data 33 for the portion of the log data 30 that differs from the log data 41 included in the second data set 40b.

In the next step S13, processor 11 controls the transmission device 10 to send the location information 32, difference data 33, and identifier 42 included in the second data set 40b instead of the log data 30. In the example shown in FIG. 13, processor 11 reads the identifier 42_0 included in the data set 40_0 identified as the second data set 40b. Then, processor 11 adds a header 60 to the location information 32, difference data 33, and identifier 42_0, and encodes the header 60, location information 32, difference data 33, and identifier 42_0. After that, processor 11 controls the communication interface 14 to send the packet 70 including the encoded header 60, location information 32, difference data 33, and identifier 42_0 to the receiving device 20.

The flow shown in FIG. 12 is executed each time the receiving device 20 receives the packet 70. The flow shown in FIG. 12 differs from the flow shown in FIG. 5 in that it includes steps S51 to S54. Therefore, the differences will be explained. Note that the instruction group for executing steps S51 to S54 by processor 21 is included in the communication program 27.

As shown in FIG. 12, if the newly generated log data 30 is not received (NO in step S41), the process moves to step S51. In step S51, processor 21 of the receiving device 20 determines whether the difference data 33 has been received. Specifically, as shown in FIG. 13, processor 21 decodes the received packet 70. Processor 21 determines whether the decoded packet 70 includes the difference data 33 based on the decoded header 60, for example. If the packet 70 includes the difference data 33, the processor 21 determines that the difference data 33 has been received.

If the difference data 33 is not received (NO in step S51), steps S44, S45 are executed.

If the difference data 33 is received (YES in step S51), the process moves to step S52. In the example shown in FIG. 13, packet 70 includes the difference data 33. Therefore, processor 11 determines that the difference data 33 has been received and executes step S52.

In step S52, processor 21 reads the log data 41 corresponding to the received identifier 42 from the cache 22. In the example shown in FIG. 13, processor 11 reads the log data 41_0 corresponding to the identifier 42_0 from the cache 22.

In the next step S53, processor 21 generates converted data 44 by replacing the portion data 43 at the position indicated by the location information 32 in the read log data 41 with the difference data 33. In the example shown in FIG. 13, processor 11 replaces the portion data 43 of the log data 41_0 with the difference data 33 (see FIG. 10).

In the next step S54, processor 21 outputs the converted data 44 to the log management application 26 as newly generated log data 30. As mentioned above, the converted data 44 matches the log data 30. Therefore, as shown in FIG. 13, the log management application 26 can manage the converted data 44 as newly generated log data 30.

According to the second embodiment, if the cache 12 stores the second data set 40b instead of the first data set 40a, location information 32, differential data 33, and identifier 42 are transmitted instead of log data 30. The data amount of the set of location information 32, differential data 33, and identifier 42 is less than the amount of log data 30. Therefore, the communication load of log data between the transmission device 10 and the reception device 20 is further reduced.

### Third Embodiment

Communication system 1B according to the third embodiment has the similar configuration to the communication system 1 according to the first embodiment (see FIG. 1). Communication system 1B is expected to perform processing that further reduces the communication load of log data between the transmission device 10 and the reception device 20 compared to the communication system 1A according to the second embodiment.

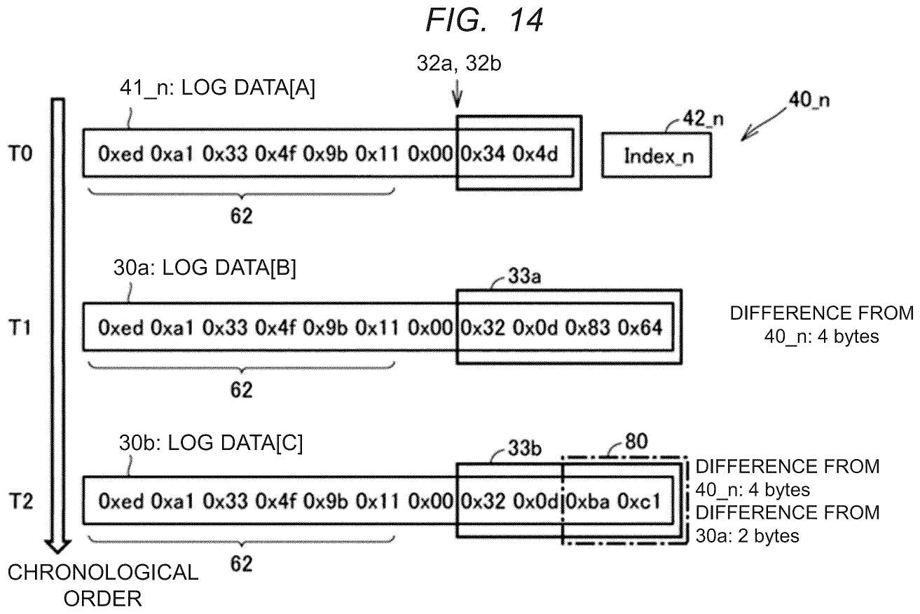

Referring to FIG. 14, issues that may arise in communication system 1A according to the second embodiment will be described. FIG. 14 is a diagram showing an example of processing in the communication system according to the second embodiment. In the example shown in FIG. 14, at timing T0, the cache 12 stores the data set 40_n including log data 41_n. At timing T1 after timing T0, log data 30a is generated. Furthermore, at timing T2 after timing T1, log data 30b is generated.

In the example shown in FIG. 14, log data 30a and log data 41_n match in a specific part 62. Therefore, at timing T1, processor 11 identifies the data set 40_n including log data 41_n as the second data set 40b. As a result, processor 11 controls the transmission device 10 to send location information 32a, differential data 33a, and identifier 42_n instead of log data 30a. In the example shown in FIG. 14, the differential data 33a is 4 bytes.

Similarly, log data 30b and log data 41_n match in a specific part 62. Therefore, at timing T2, the processor 11 identifies the data set 40_n including log data 41_n as the second data set 40b. As a result, the processor 11 controls the transmission device 10 to send location information 32b, differential data 33b, and identifier 42_n instead of log data 30b. In the example shown in FIG. 14, the differential data 33b is 4 bytes.

By the way, the application 16 can generate log data while gradually changing it. In this case, the newly created log data is most similar to the log data created immediately before. In the example shown in FIG. 14, log data 30b is more similar to log data 30a than log data 41_n. Specifically, the differential data 80 of the part of log data 30b that differs from log data 30a is 2 bytes. Therefore, if differential data 80 can be sent instead of differential data 33b, the amount of differential data 33 can be further reduced. However, in the second embodiment, when differential data 33 is sent instead of log data 30, the data set 40 including the log data 30 as communicated log data 41 is not stored in the cache 12. That is, in the example shown in FIG. 14, the data set 40 including log data 30a as log data 41 is not stored in the cache 12. As a result, the effect of further reducing the amount of differential data 33 does not occur.

Therefore, communication system 1B according to the third embodiment performs the following processing to further reduce the amount of differential data 33 as described above.

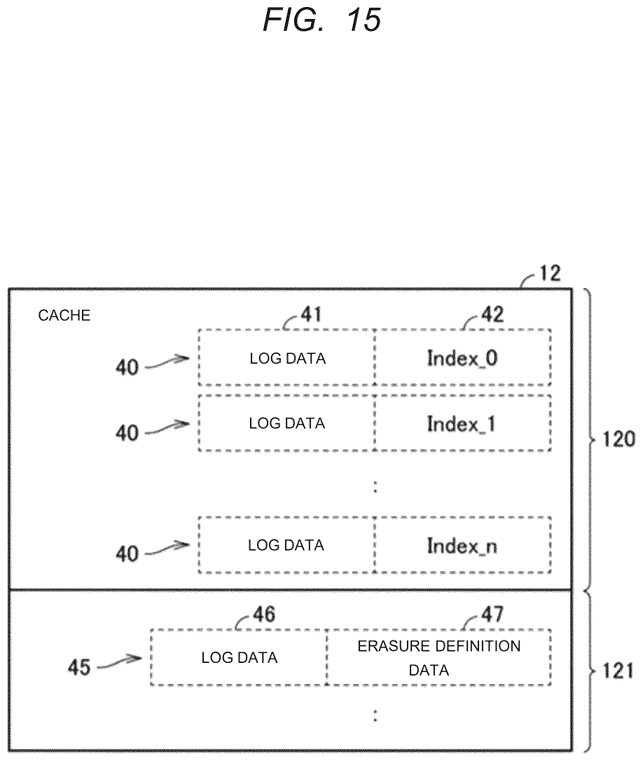

FIG. 15 is a diagram showing the configuration of the cache provided in the transmission device according to the third embodiment. As shown in FIG. 15, the cache 12 includes a main area 120 and a local area 121. The main area 120 stores one or more data sets 40. The local area 121 stores one or more temporary data sets 45.

The temporary data set 45 includes log data 46 communicated from transmission device 10 to the reception device 20 in the past, and erasure definition data 47.

The erasure definition data 47 defines the timing for erasing the temporary data set 45. For example, the erasure definition data 47 indicates the timing when a predetermined period has elapsed since the temporary data set 45 was stored in cache 12. In this case, processor 11 erases the temporary data set 45 including the erasure definition data 47 from the cache 12 in response to that the current time reaches the timing indicated by the erasure definition data 47.

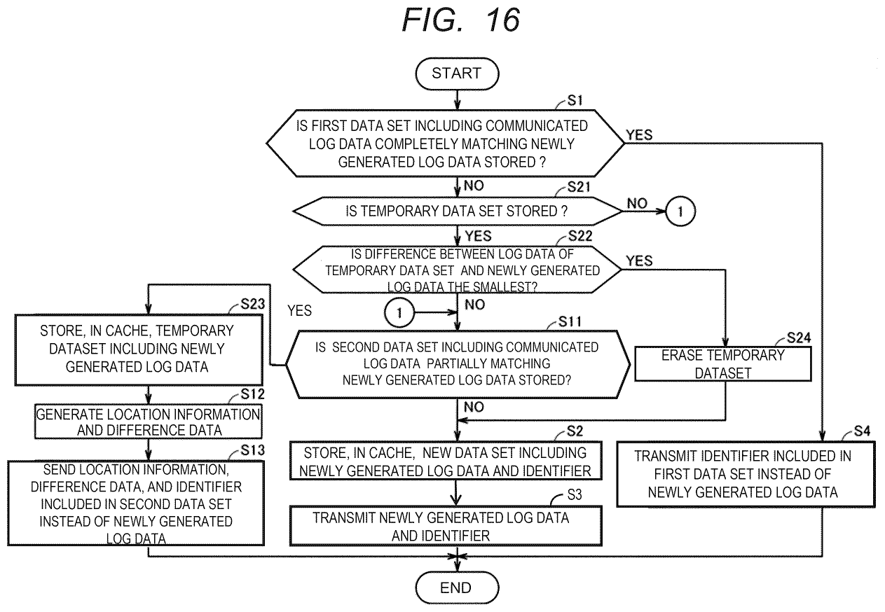

Alternatively, the erasure definition data 47 may indicate a reference count. In this case, processor 11 erases the temporary data set 45 including the erasure definition data 47 from the cache 12 in response to that log data 46 has been referenced the number of times of the reference count indicated by the erasure definition data 47. As will be described later, log data 46 is referenced by processor 11 in step S22 shown in FIG. 16. Therefore, processor 11 erases the temporary data set 45 from the cache 12 after the number of times step S22 is executed reaches the reference count, after storing the temporary data set 45 in the cache 12. Alternatively, processor 11 may erase the temporary data set 45 including the erasure definition data 47 from the cache 12 in response to that the number of times new log data 30 is generated reaches the reference count indicated by the erasure definition data 47. That is, processor 11 erases the temporary data set 45 from the cache 12 after the number of times log data 30 is generated reaches the reference count after storing the temporary data set 45 in the cache 12.

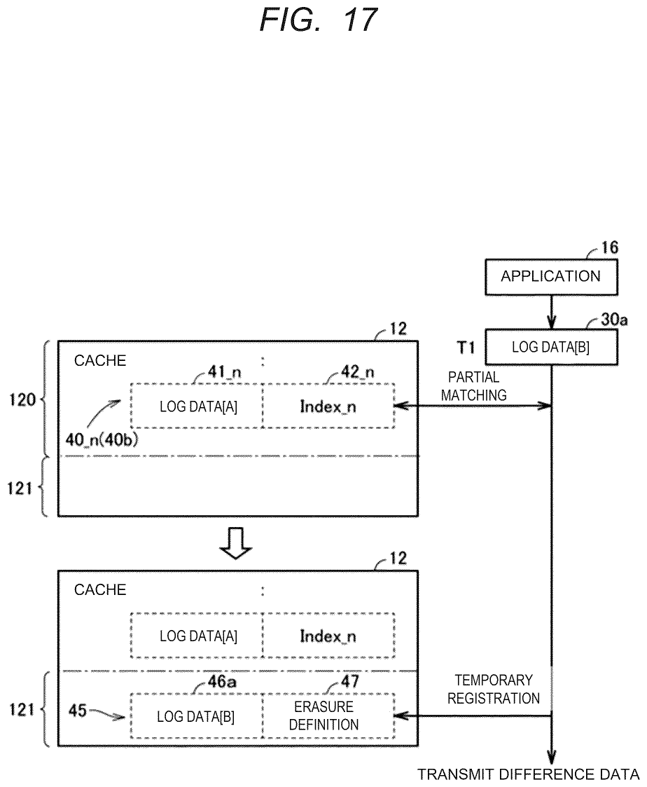

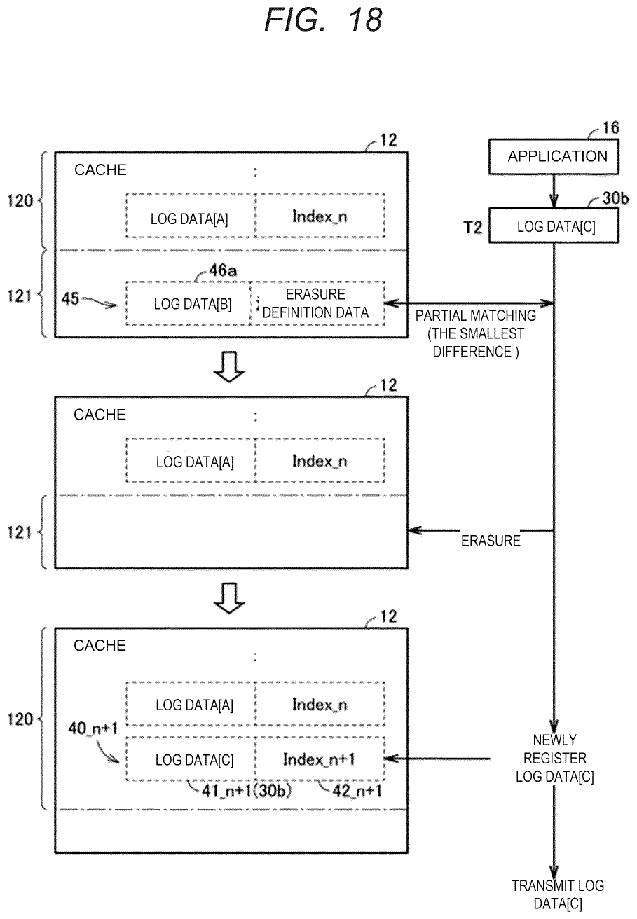

Referring to FIGS. 16 to 18, the processing flow of the transmission device 10 according to the third embodiment will be described. FIG. 16 is a flowchart showing the processing flow of the transmission device according to the third embodiment. FIG. 17 is a diagram showing the data flow in the transmission device when YES is determined in step S11 shown in FIG. 16. FIG. 18 is a diagram showing the data flow in the transmission device when YES is determined in step S22 shown in FIG. 16. Note that FIGS. 17 and 18 show an example when n+1 data sets 40 (data sets 40_0 to 40_n) are stored in the main area 120 of the cache 12 at the start of step S1.

The flow shown in FIG. 16 is executed each time the application 16 newly generates log data 30. The flow shown in FIG. 16 differs from the flow shown in FIG. 11 in that it includes steps S21 to S24. The differences will be described below. Note that the instruction set for executing steps S21 to S24 by processor 11 is included in the communication program 17.

As shown in FIG. 16, if the first data set 40a is not stored in cache 12 (NO in step S1), the process moves to step S21. In step S21, processor 11 of the transmission device 10 determines whether a temporary data set 45 is stored in the local area 121 of the cache 12.

If a temporary data set 45 is stored (YES in step S21), the process moves to step S22. In step S22, processor 11 determines whether the difference between log data 46 and newly generated log data 30 is the smallest among log data 41, 46 stored in the cache 12.

If a temporary data set 45 is not stored (NO in step S21), or if the difference between log data 46 and newly generated log data 30 is not the smallest (NO in step S22), the process moves to step S11. In the example shown in FIG. 17, at timing T1 when log data 30a is newly generated, no temporary data set 45 is stored in the local area 121 of the cache 12. Therefore, at timing T1, processor 11 determines that no temporary data set 45 is stored and executes step S11.

In the third embodiment, in step S11, processor 11 determines whether the second data set 40b is stored in the main area 120 of the cache 12. As described above, the second data set 40b is a data set that includes communicated log data 41 that matches at, at least a specific part 62, with the newly generated log data 30.

If the second data set 40b is not stored in the main area 120 of the cache 12 (NO in step S11), the processor 11 executes steps S2 and S3.

If the second data set 40b is stored in the main area 120 of the cache 12 (YES in step S11), the process moves to step S23. In the example shown in FIG. 17, log data 41_n matches at, at least a specific part 62 (see FIG. 9), with log data 30a. Therefore, processor 11, after identifying the dataset 40_n containing log data 41_n as the second dataset 40b, performs step S23.

In step S23, the processor 11 generates a temporary dataset 45 that includes the newly generated log data 30 as log data 46 and also includes erasure definition data 47. Then, the processor stores the temporary dataset 45 in the local area 121 of the cache 12. In the example shown in FIG. 17, a temporary dataset 45 containing log data 30a as log data 46a is stored in the local area 121.

After step S23, steps S12 and S13 are performed. That is, processor 11 generates location information 32 and difference data 33 based on the comparison result between the second dataset 40b and the newly generated log data 30. Then, processor 11 controls the transmission e 10 to send the location information 32, difference data 33, and identifier 42 included in the second dataset 40b instead of the newly generated log data 30.

If the difference between log data 46 and the newly generated log data 30 is the smallest (YES in step S22), the process moves to step S24. In the example shown in FIG. 18, at the timing T2 when the log data 30b is newly generated, a temporary dataset 45a is stored in the local area 121 of the cache 12. And the difference between log data 46a included in the temporary dataset 45a and log data 30b is smaller than the difference between any log data 41 stored in the main area 120 and log data 30b. Therefore, processor 11 determines that the difference between log data 46a and the newly generated log data 30b is the smallest and performs step S24.

In step S24, processor 11 erases the temporary dataset 45 containing log data 46, which is determined to have the smallest difference from the newly generated log data 30, from the cache 12. In the example shown in FIG. 18, processor 11 erases the temporary dataset 45a containing log data 46a, which has the smallest difference from log data 30b, from cache 12.

After step S24, the processor 11 performs steps S2 and S3. That is, processor 11 stores a new dataset 40 containing the newly generated log data 30 as communicated log data 41 and containing a new identifier 42 in the main area 120 of the cache 12. Then, the processor 11 controls the transmission device 10 to send the log data 30 and the new identifier 42_n. In the example shown in FIG. 18, processor 11 stores a dataset 40_n+1 containing log data 30b as communicated log data 41_n+1 and containing identifier 42_n+1 in the main area 120 of the cache 12. Then, the processor 11 controls the transmission device 10 to send the log data 30b and identifier 42_n+1.

The processing flow of the receiving device 20 according to the third embodiment is the same as the flow shown in FIG. 12. Therefore, a detailed description of the processing flow of the receiving device 20 is omitted.

According to communication system 1B of the third embodiment, even when the difference between log data 46 included in the temporary dataset 45 and the newly generated log data 30 is the smallest, steps S2 and S3 are performed.

As mentioned above, application 16 can generate log data while making slight changes. Therefore, when the difference between log data 46 included in the temporary dataset 45 and the newly generated log data 30 is the smallest, the application 16 is likely to continue generating similar log data. Therefore, by storing the dataset 40 containing the log data 30 as log data 41 in the cache 12 in step S2, the processor 11 can generate smaller-sized difference data 33 for the continuously generated log data. In other words, the communication volume for transmitting the continuously generated log data to the receiving device 20 can be further suppressed.

The present disclosure also includes the following configurations.

### First Configuration

A control method for a transmission device that sends log data to a receiving device,
wherein the transmission device includes a first cache, the first cache storing one or more datasets that are the same as those included in a second cache in the receiving device, and each of the one or more datasets including communicated log data and an identifier assigned to the communicated log data;
wherein the control method includes:
determining, by a processor, whether a first dataset that includes the communicated log data that exactly matches first log data generated by an application is stored in the first cache; and
controlling, by the processor, the transmission device to send the identifier included in the first dataset to the receiving device instead of the first log data, in response to the first dataset being stored in the first cache.

### Second Configuration

A control method for controlling a receiving device that receives log data from a transmission device that generates the log data,
wherein the receiving device includes a second cache configured to store the same data as the first cache provided in the transmission device; and
wherein the second cache stores one or more datasets including communicated log data and an identifier assigned to the communicated log data;
wherein the control method includes:
reading, by a processor, the communicated log data corresponding to the identifier from the second cache in response to receiving the identifier from the transmission device instead of the first log data generated by the transmission device; and outputting, by the processor, the communicated log data read from the second cache as the first log data to an application that manages the log data.

### Third Configuration

A program for causing the processor to execute the control method described in the First or Second Configuration.

Although the invention made by the present inventor has been specifically described based on the embodiments, the present invention is not limited to the embodiments as described 10 above, and it is needless to say that various modifications can be made without departing from the gist thereof.

What is claimed is:

1. A communication system for communicating log data, comprising:
a transmission device; and
a receiving device,
wherein the transmission device includes:
a first cache; and
an application that generates the log data,
wherein the receiving device includes a second cache;
wherein the first cache and the second cache store one or more datasets including communicated log data and an identifier assigned to the communicated log data;
wherein the transmission device sends the identifier included in the first dataset instead of the first log data, in response to that the first dataset containing the communicated log data that completely matches the first log data generated by the application is stored in the first cache; and
wherein the receiving device reads the communicated log data corresponding to the identifier received from the transmission device from the second cache and manages the read communicated log data as the first log data.

2. The communication system according to claim 1,
wherein the transmission device, in response to that the first dataset is not stored in the first cache,
assigns a new first identifier to the first log data;
sends the first log data and the new first identifier; and
stores a new dataset containing the first log data as communicated log data and the new first identifier in the first cache, and
wherein the receiving device, in response to that the first log data and the new first identifier are received, stores a new dataset containing the first log data as communicated log data and the new first identifier in the second cache.

3. The communication system according to claim 2,
wherein the transmission device encodes the first log data and the new first identifier, then sends the first log data and the new first identifier; and
wherein the receiving device decodes the first log data and the new first identifier received from the transmission device.

4. The communication system according to claim 1,
wherein the transmission device:
determines, in response to that the first dataset is not stored in the first cache, whether a second dataset containing communicated log data that matches at least a specific part of the first log data is stored in the first cache;
generates, in response to that the second data set is stored in the first cache, location information indicating the position of the part of the communicated log data included in the second dataset that does not match the first log data and difference data for the part of the first log data that differs from the communicated log data included in the second dataset; and
sends the location information, difference data, and identifier included in the second dataset instead of the first log data; and
wherein the receiving device, in response to that it receives the location information, difference data, and identifier:
reads the communicated log data corresponding to the identifier from the second cache;
replaces the part data of location indicated by the location information in the communicated log data read from the second cache with the difference data to generate converted data; and
manages the converted data as the first log data.

5. The communication system according to claim 4,
wherein the specific portion is a continuous portion of a predetermined size from the beginning, and
wherein the location information indicates the offset from the beginning to the start position of the non-matching portion in the communicated log data included in the second data set.

6. The communication system according to claim 4,
wherein the specific portion is a continuous portion of a predetermined size to the end, and
wherein the location information indicates the offset from the beginning to the end of the non-matching portion in the communicated log data included in the second data set.

7. The communication system according to claim 4,
wherein the specific portion includes a first portion that is continuous for a predetermined size from the beginning and a second portion that is continuous for a predetermined size to the end, and
wherein the location information indicates a first offset from the beginning to the start position of the non-matching portion and a second offset indicating the offset amount from the beginning to the end of the non-matching portion in the communicated log data included in the second data set.

8. The communication system according to claim 4,
wherein the transmission device in response to that it identifies two or more data sets from the first cache that include communicated log data with at least the specific portion matching the first log data, identifies, among the two or more data sets, the data set containing the communicated log data with the smallest difference from the first log data as the second data set.

9. The communication system according to claim 4,
wherein the transmission device stores, in response to that the second data set is included in the first cache, a provisional data set containing the first log data as communicated log data in the first cache;
wherein the application generates second log data after generating the first log data;
wherein the transmission device, based on the first difference between the second log data and the communicated log data in the provisional data set being smaller than the second difference between the second log data and the communicated log data contained in one or more data sets:
assigns a new second identifier to the second log data;
transmits the second log data and the new second identifier; and
stores a new data set containing the second log data as communicated log data and containing the new second identifier in the first cache, and
wherein the receiving device, upon receiving the second log data and the new second identifier, stores a new data set containing the second log data as communicated log data and containing the new second identifier in the second cache.

10. The communication system according to claim 9,
wherein the provisional data set includes definition data that defines the erasure timing; and
wherein the transmission device erases the provisional data set from the first cache after the erasure timing has passed, based on the definition data.

11. The communication system according to claim 9,
wherein the transmission device erases the provisional data set from the first cache based on the first difference being smaller than the second difference.

12. A transmission device for transmitting log data to a receiving device, comprising:
a first cache;
an application that generates the log data; and
a processor,
wherein the first cache stores the same one or more data sets as the second cache included in the receiving device, each of the one or more data sets including communicated log data and a uniquely assigned identifier to the communicated log data; and
wherein the processor controls the transmission device to send the identifier included in the first data set to the receiving device instead of the first log data, based on the first data set containing communicated log data that completely matches the first log data generated by the application being stored in the first cache.

13. A receiving device for receiving log data from a transmission device that generates the log data, comprising:
a second cache configured to store the same data as the first cache provided by the transmission device;
an application that manages the log data; and
a processor,
wherein the second cache stores one or more data sets including communicated log data and an identifier assigned to the communicated log data;
wherein the processor reads the communicated log data corresponding to the identifier from the second cache based on receiving the identifier from the transmission device instead of the first log data generated by the transmission device; and
wherein the application manages the communicated log data read from the second cache as the first log data.
